(19) United States
(12) Patent Application Publication
(10) Pub. No.: US 2011/0284536 A1
(43) Pub. Date: Nov. 24, 2011

(54) One Way Degassing Valve

(76) Inventor: William Walters, Allentown, PA (US)

(21) Appl. No.: 13/113,068

(22) Filed: May 22, 2011

Related U.S. Application Data
(60) Provisional application No. 61/347,413, filed on May 22, 2010.

(51) Int. Cl. B65D 51/16; B23P 11/00

(52) U.S. Cl. 220/203.03; 29/890.124

(57) ABSTRACT

A label type degassing valve with a vented flexible cover and a base with a central aperture. The base is adhered to the cover with an adhesive layer or coating that is positioned and shaped not to interfere with the vents. The vents are generally positioned off center in the cover. For the adhesive coating, there is a deactivated central region of the coating facing the base so that no part of the deactivated central region is adhered to the base and at least one of the vents is cut through the cover and through the deactivated central region.

This application claims priority to U.S. Provisional Application 61/347,413 filed May 22, 2010.

### TECHNICAL FIELD

The invention relates to degassing valves; more particularly, it relates to an adhesive multi-layer one way degassing valve.

### BACKGROUND OF THE INVENTION

Gas must be vented out of certain packages containing off-gassing products (i.e. coffee) to prevent the package from puffing up or bursting. At the same time air (in which the active spoilage agent is believed to be oxygen) which can degrade products must be prevented from entering the package. This can be accomplished by attaching to a package a one-way degassing valve device capable of venting gas and preventing air ingress. In some cases it is desirable for the device to attach to the exterior of a package by means of pressure sensitive adhesive such as the kind used on labels. Such conventional degassing valves are often referred to as label-type for that reason.

One patent describes a label-type valve with one or two sheets with a cohesive, non-volatile liquid having relatively high surface tension enclosed in a porous member between the package wall and one of the sheets or between two sheets. The top sheet has exit holes for the exhaust gas from the interior of the package, and pressure from the interior of the package gets high enough, the porous element is broken and the gas escapes. After pressures are equalized, the valve closes again. (U.S. Pat. No. 4,134,535)

Such valves however leave something to be desired in their degassing capabilities and their resistance to letting oxygen back in through the valve.

The pressure sensitive label degassing valve applied to the exterior of a package has the advantage of speed of application over molded degassing valves that are heat sealed to the interior of the bag (e.g. Pacific Bag Inc. items 201 and 101 one-way degassing valves). Molded valves can be heat seal applied at a maximum speed of about 60-70 per minute. Labels can be applied at up to about 120 per minute.

What is needed is a simple label type valve with improved degassing and oxygen-rejecting capabilities.

### DISCLOSURE OF THE INVENTION

A pressure sensitive label type product is applied to the exterior of a package that allows gas to be vented out from a package (e.g. a flexible coffee package such as a side gusseted bag or stand-up pouch) while preventing air (and in particular, oxygen) from penetrating into the package. A performance goal of the disclosed label is to prevent package puffiness or bursting while also maintaining a relatively “low” oxygen content inside the package for some period of time to extend the shelf life of the product in the package. The term “low” here is generally associated with anything less than the normal 20.9% amount of oxygen in the atmosphere, though even lower oxygen percentages (such as 4-5% or even as low as 0.5%) are desirable and advantageous for extending the period of shelf life during which the fine oils and esters of the product will not be appreciably degraded by oxygen.

A pressure sensitive label generally in accordance with FIG. 1 is made to be affixed to the exterior of a package over a hole which is pierced in the package. The label is advantageously adhered to the exterior of the package with conventional pressure sensitive adhesive.

Prior to application of the label to the bag, a small amount of silicone oil or the like (equivalents and alternatives to silicon oil will be known to those skilled in the art), is applied to the area of a hole or aperture in the center of the base of the label on what will be the support surface side of the device or valve; that is, the side facing the bag. The silicone oil permeates through the hole in the base and is believed to be in communication with at least some of the vents in the valve cover to create a low adhesion seal between the base and a valve cover layer, or cover.

When a positive pressure above a certain point is reached inside the package or bag, gas permeates out of the hole pierced in the package or bag and is believed to overcome the low adhesion seal of the silicone oil between the base and the cover layer. Gas then migrates out of the bag, through the hole in the base and between the base and the cover through the oil, and exits the label into the atmosphere via the slotted vents in the cover layer.

When the pressure difference between the interior and exterior of the bag becomes nearly zero, it is believed that the natural surface tension of the silicone oil re-creates a low adhesion seal between base and cover, effectively preventing the ingress of air back into the package.

Conventional degassing labels are represented by Plitek, Bosch and Celomat devices, U.S. Pat. Nos. 7,178,555, 5,727,881 and 7,490,623, respectively. One advantage the disclosed label has over the prior art is that it has fewer parts and is believed to be more economical to be produce. The Plitek and Bosch designs require three main parts: a base, relatively thick PET “rails,” and an upper PET cover layer. The Celomat design requires two separate, laterally spaced apart sectors in the valve: one having oil and one having an air bubble.

The disclosed label has two main parts: a base and a flexible film cover layer with vents. The base has a circular, non-adhesive area in the center, or in some cases an aperture in the center. The circular non-adhesive area or aperture is believed to create a chamber between the base and the cover that provides a path for gas to escape.

The disclosed label has no “inner rail members” and no “rectangular passage” such as formed by the two relatively thick (8-10 mils) pieces of PET that create a channel through which gas is released in the Plitek design. The label has no special shaped valve hole or an axis for that hole, such as required in the Bosch design; likewise there are no parallel peripheral zones that form a channel zone. The disclosed label also has only a single sector occupied by both gases and fluid.

What is disclosed is a label type degassing valve with a vented flexible cover and a base with a central aperture. The vents can be any shape, size, number and length, but two short slits are believed to be advantageous. The central aperture can likewise be any size and shape, but a generally round aperture that is considerably smaller in diameter than the width of the label valve cover is preferred.

The base is adhered to the cover with an adhesive layer or coating that is positioned and shaped not to interfere with the vents. The vents are generally positioned off center in the cover. This is believed to improve oxygen rejection by providing a slightly longer or tortuous path for any air to travel that might try to get back in. Preferred embodiments will have all vents off center and spaced to be offset outwardly from the perimeter of the central aperture, again to advantageously extend the length of air passage from outside to inside. To this purpose and effect, the deactivated zone of adhesive, and/or the opening in the adhesive layer are preferably wider than (which is to say overlaps) the aperture in the base.

For the adhesive coating, there is a deactivated central region of the coating facing the base so that no part of the deactivated central region is adhered to the base and at least one of the vents is cut through the cover and through the deactivated central region.

In preferred embodiments, a quantity of oil is disposed at least within the central aperture of the base, and the number of vents is two and both are disposed and cut through the cover and adhesive coating in the deactivated central region. The deactivated central region is advantageously the same general shape as the aperture in the base and it also overlaps the aperture. Vents disposed and cut through the cover and adhesive coating in the deactivated central region are advantageously offset from the aperture in the base to provide a kind of tortuous path for air, if any, to pass through the oil and back into the bag.

In an alternate label type degassing valve, the base is adhered to the cover with an adhesive layer, either a pattern-cut piece of two-sided adhesive, or a pattern-applied adhesive coating, such that the adhesive layer has an opening generally commensurate in shape with the aperture in the base. The opening in the adhesive layer advantageously overlaps the aperture so that at least one of the vents is offset from the aperture. A quantity of oil is disposed at least within the central aperture of the base, and the oil is in communication with at least one of the vents.

A method of making a degassing label is also disclosed. In the method, a conventional adhesive is applied to substantially all of the inner surface of a cover piece, and a central portion of the adhesive is then deactivated by applying an adhesive deactivating agent to a central portion of the adhesive (in a generally central portion of the cover).

The cover and adhesive are then fenestrated with a plurality of vents, at least one of which is let into the deactivated portion of the adhesive. The cover is adhered to a base that has a generally central aperture by means of the peripheral portions of adhesive on the cover that remain actively sticky. A very small quantity of oil is applied to the base in the central aperture, and the base is adhered with a pressure sensitive adhesive to a container or bag into which has been pierced a small hole, such that the central aperture is generally centered on the hole.

An alternative to using a patterned adhesive or 2-sided adhesive film between cover and base is to create a non-adhering area in the center of the label between the cover and base. Instead of coating the underside or inner surface of the cover with adhesive in a pattern or using an adhesive film with a hole cut into it as shown generally in FIG. 1, a generally full coating of adhesive is applied to the inner surface of the cover. It is advantageous to make the adhesive coating cover about 100% of the inner surface of the cover, but smaller percentages can still be made to work. A “deadener” is then painted over this coating of adhesive in a selected pattern or shape, such as the shape of a square, to create a deadened adhesive area; that is a non-adhesive area as shown generally in FIG. 4. The deadener is a lacquer or an ink or the like that covers the adhesive and makes it not sticky in the area where it is applied. This deadened, non-sticky area (also called a deactivated area) provides the non-adhered area or opening generally designated at numeral 7 in FIG. 1 and at number 12 in FIG. 4.

### BRIEF DESCRIPTION OF THE DRAWINGS

FIG. 1 is an exploded perspective schematic of the disclosed label valve.

FIG. 2 is a cross-sectional schematic of the disclosed label valve.

FIG. 3 is an alternate cross-sectional schematic of the disclosed label valve.

FIG. 4 is an alternate cross-sectional schematic of the disclosed label valve.

### BEST MODE OF CARRYING OUT THE INVENTION

Turning now to the drawings, the invention will be described in a preferred embodiment by reference to the numerals of the drawing figures wherein like numbers indicate like parts.

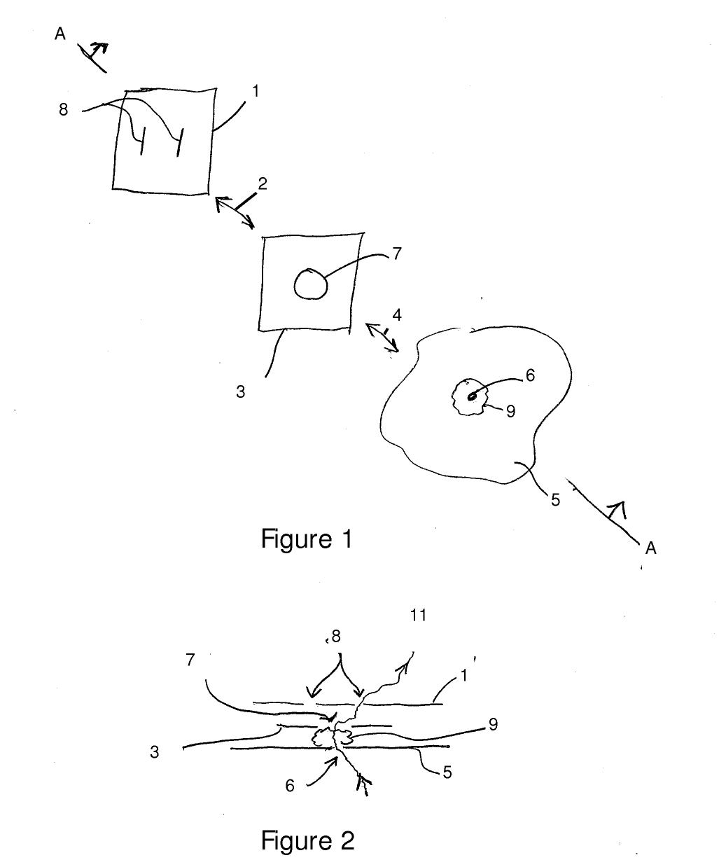

FIGS. 1, 2, 3 and 4 are simple illustrations of the disclosed label valve system. Generally, a cover 1 is disposed over a base 3. Cover 1 is advantageously adhered with adhesive 2 over base 3 which is in turn adhered to bag surface 5 with adhesive 4. Bag surface 5 of bag 10 has small hole 6, desirably a pin-like perforation in bag surface 5. A drop of oil 9 lies over pin hole 6 and generally occupies the space between base 3 and cover 1 in the area left open by aperture (or hole or void) 7 in base 3.

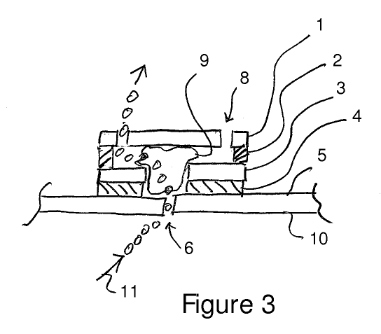

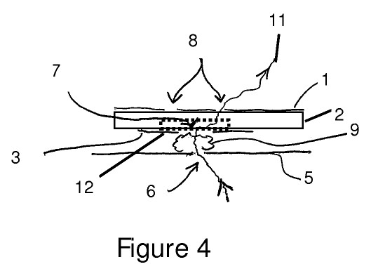

FIG. 1 is an exploded schematic, and FIG. 2 is cross-sectional schematic. FIGS. 3 and 4 are cross-sections taken along lines A-A in FIG. 1, and thickness dimensions in all figures and line thicknesses are exaggerated for clarity of illustration.

When pressure rises inside bag 10 to greater than atmospheric (FIG. 3), gas escapes from inside bag 10, through hole 6, through oil 9 and finds its way on a kind of tortuous path to one or more of vents 8 in cover 1. It is believed that the layered structure and preferred thin film material of cover 1 allow for at least some slight upward (from the perspective of FIG. 3) bulging or doming of the area in cover 1 between slots 8, and thus make relief of the pressure somewhat easier, as the small degree of adhesion in that area between base 3 and cover 1 is somewhat reduced by this bulging deformation. A bubble path 11 is schematically illustrated along the direction of the arrows on path 11.

Vents 8 are generally slot-like cuts in cover 1, and may generally and alternatively be any shape such as short straight cuts, or arced or curved cuts, and these cuts may desirably be positioned anywhere and in any reasonable number along the relative periphery of a central area of cover 1, so long as most or all of such cuts or vents are disposed away from the center of cover 1 and yet not so far out toward the periphery of cover 1 that they are clogged or closed by adhesive 2. Cut vents 8 may be generally parallel to cover edges, or generally skewed or diagonal, or a combination of parallel and skewed.

Cover 1 material may be a PET film, a laminate of PET/PE, or other flexible and resilient materials. Adhesives 2 and 4 may desirably be 2 side adhesive film, cut or patterned so as to leave vents 8 and base aperture 7 free from adhesive and open. The area remaining free in the center of adhesive 2 can be circular or generally square or some other shape. Some care is advantageous to insure that most if not all of at least the periphery of the base and cover are covered with adhesive where they connect with each other, and with bag surface 5.

In FIG. 1, cover 1 with vents 8 is adhered by adhesive 2 to base 3 which has aperture 7. Base 3 is adhered to bag surface 5 by pressure sensitive adhesive 4, centered over hole in bag 6, over which is drop of oil 9.

Schematically, in FIG. 2, off gases leave bag 5 through hole 6, passing through oil 9, aperture 7 in base 3, and out vents 8 in cover 1 generally along path 11. In this figure, adhesives 2 and 4 are not specifically shown, but are generally located respectively between cover 1 and base 3 and between base 3 and bag 5. Generally, there is no adhesive (either a hole, or a deactivated zone) in any region where path 11 passes. This may be because there is hole in a layer of adhesive generally identified herein as adhesive 2, or because the adhesive coating 2 has deactivated zone 12 (FIG. 4).

FIG. 3 shows gas bubbles schematically leaving bag 10 along path 11 through hole in bag 6, passing through oil 9 and out vents 8 in cover 1. This view generally better shows the positioning of adhesives 2 and 4 and generally illustrates the openings or gaps in the adhesive and how they are positioned to avoid any interference with path 11 as gases leave the bag. This view also better illustrates the overlap of the opening in the adhesive between cover and base and how it sized and shaped to overlap aperture 7 in base 3.

FIG. 4 is an alternate of FIG. 2 that better illustrates the applied adhesive coating 2 which in turn has had zone 12 deactivated in a pattern and width that likewise overlaps aperture 7 in base 3. Omitted for clarity of drawing is the detail on how vents 8 are cut completely through both cover 1 and adhesive layer 2. But in this view it can be seen that vents 8 drop down to the surface of base 3 at points that are outside the periphery of aperture 7 of base 3 as they pass through deactivated zone 12.

### Examples

Thirty-four hand-made prototypes of the label are placed on test pouches. The pouches are flushed with nitrogen to less than 3% oxygen and stored at room temperature. After 32 days of storage, the test pouches are tested for percentage oxygen content inside the pouches. The tests show 27 of the packages have less than 1% oxygen in them. Of the seven packages that failed to maintain such low percentage oxygen, five of them are believed to have an assignable cause for the failure such as a wrinkle in the tape used to seal the gas flush hole or a defect in the label from the handmaking operation (e.g. a score in the PET/PE layer that caused curling). It is believed that manufacturing under controlled, production environment will produce consistent, reliable label valves.

Further testing of a batch of 50,000 valves of the disclosed design has been conducted on industrial label making equipment to simulate actual, commercial production, and to see if the disclosed label valves would allow gas from actual coffee to be released from the package; to see if oxygen is prevented or reduced from entering the package over long periods of time; and to see if the label valves can be applied on existing pressure sensitive label valve application equipment in the field.

Test of valves applied to actual commercial packages by hand and evaluated for percent oxygen by a third party. Conclusion: Over 30 days, the percent oxygen in 23 out of 30 bags (80% of bags tested) was 0.5%-0%. It is believed the 20% failures were due to difficulty in applying valves manually to post production packages.

Long term (140 days) testing of valves, comparing bags packed by N2 flush and with semi-fresh coffee packed at a customer. Control bags have N2 flush and no valve. Valves manually applied. Conclusion: valves allowed degassing and prevented O2 ingress after 140 days.

Valves applied on actual commercial equipment at a customer and shipped by UPS Ground to evaluate ability to survive shipment and tested for percent oxygen after 57 days. Conclusion: valves performed successfully.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A label type degassing valve, the valve comprising:
a. a flexible cover fenestrated with a plurality of vents, the cover further comprising, on an inner surface of the cover, an adhesive coating, and at least one of the vents not centrally positioned in the cover, at least one of the vents cut to penetrate both cover and adhesive coating;
b. a base with a central aperture, the base adhered to the cover's adhesive coating;
c. the adhesive coating being deactivated in a central region of the coating facing the base so that no part of the deactivated central region is adhered to the base, and at least one of the vents cut through the cover and through the deactivated central region.

2. The valve of claim 1 further comprising a quantity of oil disposed at least within the central aperture of the base.

3. The valve of claim 1 wherein the number of vents is two and both are disposed and cut through the cover and adhesive coating in the deactivated central region.

4. The valve of claim 1 wherein the deactivated central region is the same general shape as the aperture in the base and overlaps the aperture.

5. The valve of claim 1 wherein at least one vent is disposed and cut through the cover and adhesive coating in the deactivated central region and is offset from the aperture in the base.

6. The valve of claim 1 wherein the base is adhered to the container with a pressure sensitive adhesive.

7. A method of making a degassing label, the method comprising:
a. apply an adhesive to substantially all of the inner surface of a cover piece;
b. deactivate a central portion of the adhesive by applying an adhesive deactivating agent to the central portion of the adhesive;
c. fenestrate the cover and adhesive with a plurality of vents, at least one of which is let into the central portion of the adhesive;
d. adhere the cover to a base that has a generally central aperture;
e. apply oil to the base in the central aperture and adhere the base to a container into which has been pierced a small hole, such that the central aperture is generally centered on the hole.

8. The method of claim 7 wherein the base is adhered to the container with a pressure sensitive adhesive.

9. The method of claim 7 wherein the container is a flexible container.

10. A label type degassing valve, the valve comprising:
a. a flexible cover fenestrated with a plurality of vents, at least one of the vents not centrally positioned in the cover;
b. a base with a central aperture, the base adhered to the cover with an adhesive layer;
c. the adhesive layer having an opening generally commensurate in shape with the aperture in the base and overlapping the aperture, so that at least one of the vents is offset from the aperture.

11. The valve of claim 10 further comprising a quantity of oil disposed at least within the central aperture of the base.

12. The valve of claim 10 wherein the number of vents is two and both are disposed in the cover above the opening in the adhesive layer.

13. The valve of claim 10 further comprising a quantity of oil disposed at least within the central aperture of the base, and the oil is in communication with at least one of the vents.

14. The valve of claim 10 wherein the base is adhered to the container with a pressure sensitive adhesive.

15. The valve of claim 10 wherein the adhesive layer is a pattern-cut piece of two-sided adhesive.
